(19) United States
(12) Patent Application Publication
(10) Pub. No.: US 2011/0134548 A1
(43) Pub. Date: Jun. 9, 2011

(54) CAMERA MODULE WITH ANTI-ASTIGMATIC PROTRUSIONS ON LENS

(75) Inventor: CHENG-YI LAI, Tu-Cheng (TW)

(73) Assignee: HON HAI PRECISION INDUSTRY CO., LTD., Tu-Cheng (TW)

(21) Appl. No.: 12/777,214

(22) Filed: May 10, 2010

(30) Foreign Application Priority Data
Dec. 4, 2009 (CN) 200910310891.X

(51) Int. Cl. G02B 7/02

(52) U.S. Cl. 359/819

(57) ABSTRACT

An exemplary camera module includes a lens barrel and a lens received in the lens barrel. The lens includes an optical portion located at a center thereof and a fixing portion around the optical portion. Protrusions are formed at an outside peripheral surface of the fixing portion, and surfaces of the protrusions are slanted relative to an optical axis of the lens barrel.

### BACKGROUND

1. Technical Field

The present disclosure relates to image capture, and more particularly to a camera module for a portable electronic device.

2. Description of Related Art

Camera modules are often provided in mobile telephones, personal digital assistants and other devices, allowing convenient and practical image capture capability.

Referring to FIG. 5, a commonly used camera module includes a cylindrical lens barrel 80 and a plurality of lenses 81 received in the lens barrel 80. The lens barrel 80 defines an aperture 84 at one end thereof. Each of the lenses 81 includes an optical portion 811 located at a centre thereof and a fixing portion 813 located around the optical portion 811. The lenses 81 are affixed to an inner surface of the lens barrel 80 via the fixing portions 813, with the optical portions 811 aligning with the aperture 84. An outside surface of each fixing portion 813 of each lens 81 is cylindrical. During operation, light from an object enters the lens barrel 80 from the aperture 84 and passes through the lenses 81, finally reaching an image sensor (not shown) at the other end of the lens barrel 80 opposite from the aperture 84. The image sensor converts the light of the object introduced through the lenses 81 into digital data to generate an image.

As shown in FIG. 5, path E schematically indicates the passage of light through the lenses 81 of the camera module. Since the outside surfaces of the fixing portions 813 of the lenses 81 are cylindrical, total internal reflection is easily generated at the fixing portions 813 of the lenses 81 when the light passes through the lenses 81. Accordingly, astigmatic light is formed at the fixing portions 813 of the lenses 81, reducing the quality of the captured image.

It is thus desirable to provide a camera module which can overcome the described limitations.

### BRIEF DESCRIPTION OF THE DRAWINGS

FIG. 1 is a schematic, cross-sectional view of a camera module according to a first embodiment of the present disclosure.

FIG. 2 is an enlarged view of a circled portion II of FIG. 1.

FIG. 3 is a schematic, cross-sectional view of a camera module according to a second embodiment.

FIG. 4 is a schematic, cross-sectional view of a camera module according to a third embodiment.

FIG. 5 is a schematic, cross-sectional view of a commonly used camera module.

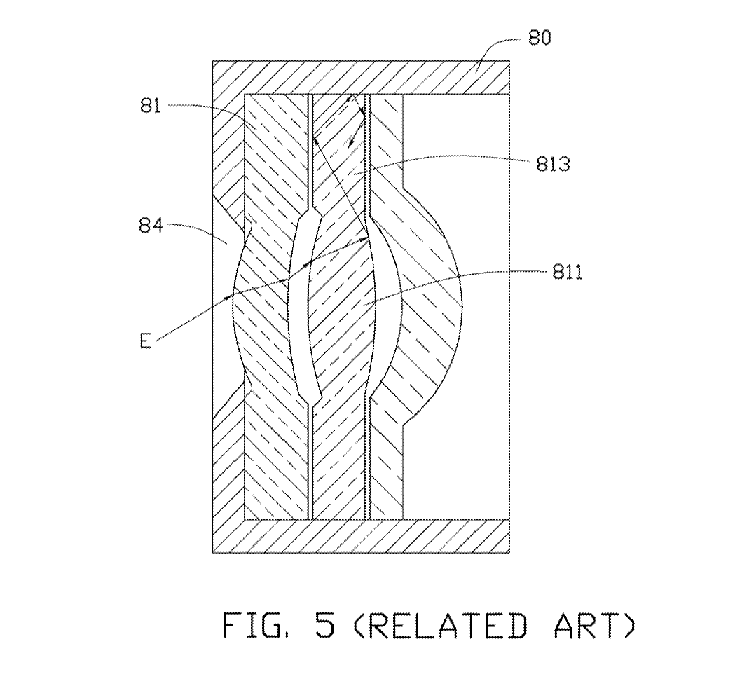

### DETAILED DESCRIPTION

Reference will now be made to the figures to describe various embodiments of the present camera module in detail.

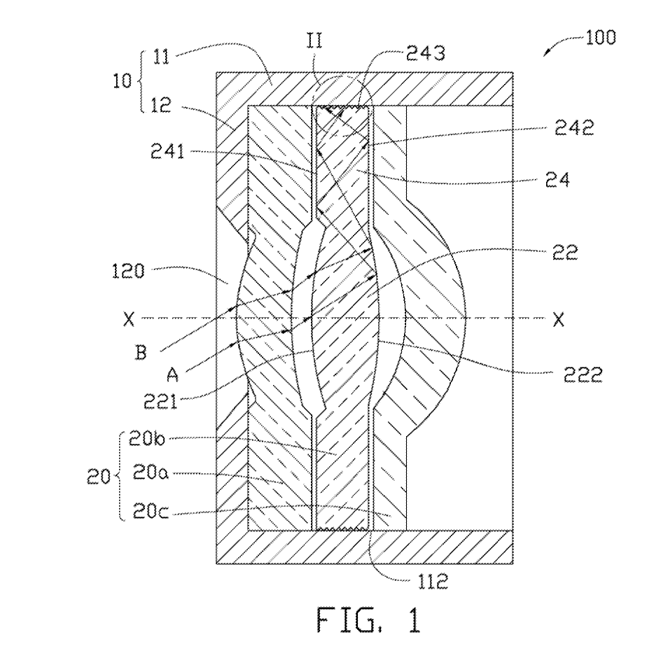

FIG. 1 shows a camera module 100 according to a first embodiment. The camera module 100 includes a lens barrel 10, a lens unit 20 and an image sensor (not shown).

The lens barrel 10 is essentially a hollow cylindrical body. The lens barrel 10 includes a hollow cylinder 11, and a flange 12 extending inwardly and perpendicular to an inner periphery of a front end of the hollow cylinder 11. The front end of the hollow cylinder 11 is at an object side of the lens unit 20. The flange 12 defines an aperture 120 at a central portion thereof admitting light into the lens barrel 10. The image sensor is arranged at the rear end of the hollow cylinder 11. The rear end of the hollow cylinder 11 is at an image side of the lens unit 20. The hollow cylinder 11 includes a cylindrical inner surface 112 surrounding the lens unit 20.

The lens unit 20 includes a first lens 20a, a second lens 20b and a third lens 20c, which are received in the lens barrel 10 and aligned along an optical axis X-X of the camera module 100 in that order from the object side to the image side. The optical axis X-X of the camera module 100 is coaxial with a central axis of the lens barrel 10. The first lens 20a, the second lens 20b and the third lens 20c are glass or plastic material. Each of the lenses 20a, 20b, 20c includes a circular optical portion 22 located at a center thereof, and a fixing portion 24 located around a periphery of the optical portion 22. The optical portion 22 includes a light incident surface 221 facing the aperture 120, and a light emitting surface 222 opposite to the light incident surface 221. Each of the light incident surface 221 and the light emitting surface 222 of the optical portion 22 can be convex or concave, and the selected configuration changes the characteristics of the light passing through the lens 20a, 20b, or 20c. For example, the light incident surface 221 and the light emitting surface 222 can be spherical or aspherical.

In this embodiment, the optical portion 22 of the first lens 20a is a meniscus portion, and includes a convex light incident surface 221 facing the aperture 120 and a concave light emitting surface 222 facing the second lens 20b. The optical portion 22 of the first lens 20a is configured for refracting the light from an object to the optical portion 22 of the second lens 20b. The optical portion 22 of the second lens 20b is a biconvex lens aligned with the optical portion 22 of the first lens 20a. The optical portion 22 of the second lens 20b is configured for receiving the light from the first lens 20a, and refracting the light to the optical portion 22 of the third lens 20c. The optical portion 22 of the third lens 20c is a meniscus portion having a concave light incident surface 221 facing the second lens 20b and a convex light emitting surface 222 facing the image sensor. The optical portion 22 of the third lens 20c is configured for receiving the light from the second lens 20b, and refracting the light to the image sensor. Thereby, an image of the object can be formed by the image sensor.

The fixing portion 24 of each lens 20a, 20b, 20c includes an annular object-side surface 241, an annular image-side surface 242 parallel to the object-side surface 241, and a cylindrical side surface 243 interconnecting an outer periphery of the object-side surface 241 with an outer periphery of the image-side surface 242. In each lens 20a, 20b, 20c, the object-side surface 241 extends radially outwardly from a periphery of the light incident surface 221. The image-side surface 242 extends radially outwardly from a periphery of the light emitting surface 222. The fixing portions 24 are configured for contacting the inner surface 112 of the lens barrel 10 via the side surfaces 243 thereof, to secure the lenses 20a, 20b, 20c in the lens barrel 10. The object-side surfaces 241 and the image-side surfaces 242 of the first, second and third lenses 20a, 20b, 20c are planar, and are substantially perpendicular to the optical axis X-X of the camera module 100. The side surfaces 243 of the first and third lenses 20a, 20c are cylindrical, and are substantially parallel to the optical axis X-X of the camera module 100.

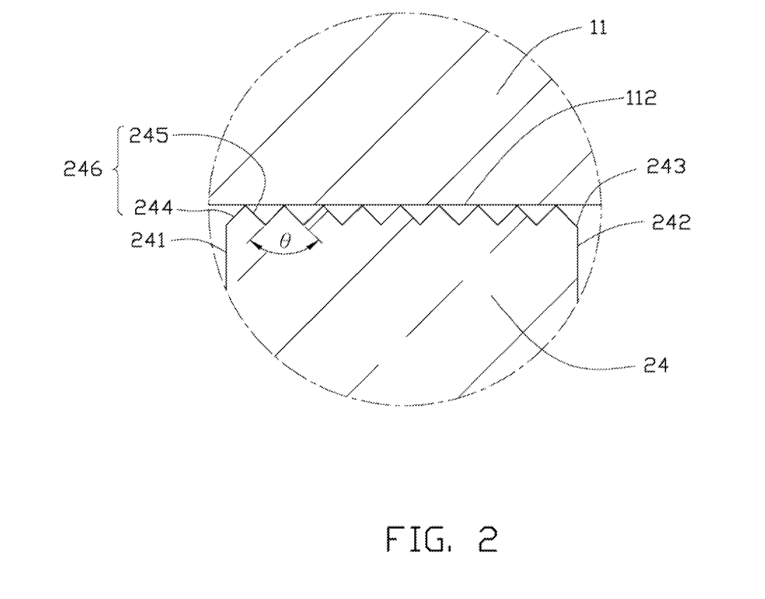

The side surface 243 of the second lens 20b has a plurality of micro protrusions 246 formed thereat. Referring to FIG. 2, the protrusions 246 are an integral part of the fixing portion 24. For example, the protrusions 246 can be formed by micro machining or etching the side surface 243. The protrusions 246 protrude radially outwardly towards the inner surface 112 of the lens barrel 10. Each of the protrusions 246 is annular and includes a first angled surface 244 oriented at an oblique angle with respect to the optical axis X-X of the camera module 100, and a second angled surface 245 oriented at an oblique angle with respect to the optical axis X-X and intersecting the first angled surface 244. The first and second angled surfaces 244, 245 cooperatively form an outer end which abuts the inner surface 112 of the lens barrel 10. An angle θ is formed between the first angled surface 244 and the second angled surface 245 of each protrusion 246. The angle θ can be from 1° to 179° according to different requirements. A transverse cross-section of each of the protrusions 246 is V-shaped.

The first angled surfaces 244 and the second angled surfaces 245 of the protrusions 246 are each frusto-conical. The protrusions 246 are arranged side by side along a direction parallel to the optical axis X-X of the camera module 100. In the present embodiment, the protrusions 246 are continuously arranged side by side. The first angled surfaces 244 of the protrusions 246 are parallel to each other. The first angled surface 244 of an outermost protrusion 246 adjacent to the object-side surface 241 extends at an oblique angle from an outer periphery of the object-side surface 241 towards the inner surface 112. The second angled surfaces 245 of the protrusions 246 are parallel to each other. The second angled surface 245 of the other outermost protrusion 246, adjacent to the image-side surface 242, extends at an oblique angle from an outer periphery of the image-side surface 242 towards the inner surface 112. The first angled surface 244 of each of the protrusions 246 between the two outermost protrusions 246 connects the second angled surfaces 245 of two neighboring protrusions 246. The second angled surface 245 of each of the protrusions 246 between the two outermost protrusions 246 connects the first angled surfaces 244 of two neighboring protrusions 246.

During image capture by the camera module 100, light from the object enters the lens barrel 10 via the aperture 120, passes through the first lens 20a, the second lens 20b and the third lens 20c, and finally reaches the image sensor. The image sensor converts the light of the object introduced through the lenses 20a, 20b, 20c into digital data to generate an image. When the light passes through the second lens 20b, most of the light incident on the light emitting surface 222 of the second lens 20b directly leaves the second lens 20b therefrom. Simultaneously, a portion of the light incident on the light emitting surface 222 of the second lens 20b is reflected by the light emitting surface 222 to a peripheral portion of the second lens 20b. The portion of the light reflected to the peripheral portion of the second lens 20b can pass through the second lens 20b mainly along two paths A and B, as shown in FIG. 1.

As indicated by the paths A and B, the light in the interior of the second lens 20b is firstly reflected by the light emitting surface 222 to the object-side surface 241 of the fixing portion 24, then reflected by the object-side surface 241 and the image-side surface 242 repeatedly generally towards the side surface 243. Since the protrusions 246 are formed on the side surface 243 of the second lens 20b, the light reflected towards the side surface 243 is apt to be incident on the first angled surfaces 244 and the second angled surfaces 245 of the protrusions 246 at reduced incident angles, respectively. Thus a significant proportion of such light can emit to an exterior of the second lens 20b via the first angled surfaces 244 and the second angled surfaces 245.

To summarize the operation and advantages of the camera module 100, the protrusions 246 of the second lens 20b include the first and second angled surfaces 244, 245 each oriented at an oblique angle with respect to the optical axis X-X of the camera module 100. Thereby, incident angles of the light which reaches the first and second angled surfaces 244, 245 are reduced compared to the case where the side surface 243 were simply a cylindrical side surface parallel to the optical axis X-X of the camera module 100. Thus, most or even all of the light reflected by the light emitting surface 222 and reaching the peripheral portion of the second lens 20b can emit to the exterior of the second lens 20b via the first and second angled surfaces 244, 245. Accordingly, total internal reflection at the side surface 243 is greatly reduced or avoided, astigmatic light at the peripheral portion of the second lens 20b is avoided, and the image quality of the camera module 100 can thus be improved. Furthermore, preferably, the inner surface 112 of the lens barrel 10 is black and can absorb the light incident thereon.

The lens unit 20 disclosed in the first embodiment has three lenses 20a, 20b, 20c, and the protrusions 246 are only formed at the side surface 243 of the second lens 20b. Alternatively, the number of the lenses included in the lens unit 20 can be varied according to need. Moreover, the protrusions 246 can be further or alternatively formed at other portions of the lens unit 20. For example, the protrusions 246 can be formed at the object-side surface 241 and the image-side surface 242 of the fixing portion 24 of the second lens 20b. In another example, the protrusions 246 can be formed at the side surfaces 243 of the fixing portions 24 of the first and third lenses 20a, 20c.

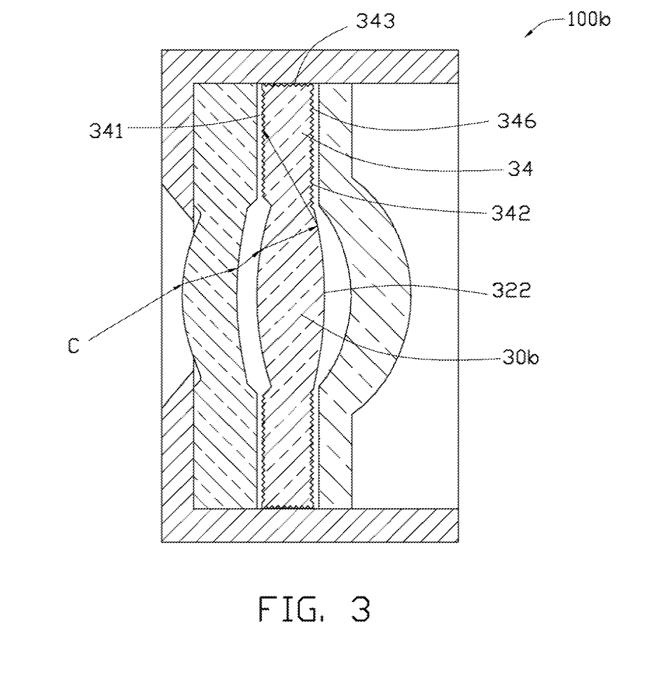

FIG. 3 shows a second embodiment of a camera module 100a. The camera module 100a differs from the camera module 100 of the first embodiment only in that a second lens 30b has a plurality of protrusions 346 formed at the entire outside surface of a fixing portion 34 thereof. That is, an object-side surface 341, an image-side surface 342 and a side surface 343 of the fixing portion 34 of the second lens 30b all have the protrusions 346 formed thereat. As shown in path C of FIG. 3, light is incident on a light emitting surface 322 of the second lens 30b, and a portion of such light is reflected by the light emitting surface 322 to the object-side surface 341 of the second lens 30b. Since the protrusions 346 are formed at the object-side surface 341, incident angles of the light which reaches the object-side surface 341 are reduced compared to the case where the object-side surface 341 were simply a planar surface. Accordingly, total internal reflection in the second lens 30b is avoided, and most or even all of the light incident on the object-side surface 341 can leave the second lens 30b through the object-side surface 341. Similarly, when a portion of the light passing through the second lens 30b is reflected to the image-side surface 342 or the side surface 343 of the second lens 30b, most or even all of the reflected light can leave the second lens 30b through the image-side surface 342 or the side surface 343.

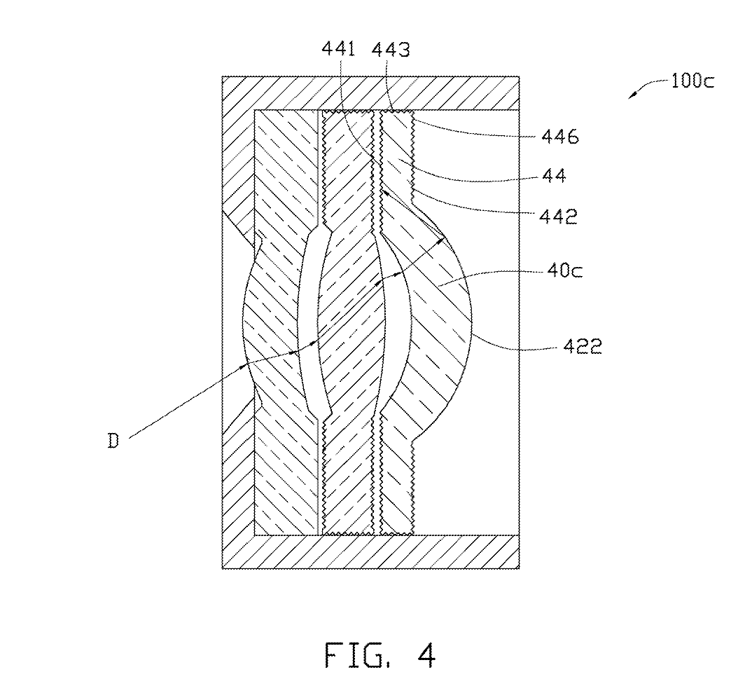

FIG. 4 shows a third embodiment of a camera module 100c. The camera module 100c differs from the camera module 100b of the second embodiment only in that a third lens 40c has a plurality of protrusions 446 formed at the entire outside surface of a fixing portion 44 thereof. That is, an object-side surface 441, an image-side surface 442 and a side surface 443 of the fixing portion 44 of the third lens 40c all have the protrusions 446 formed thereat. As shown in path D of FIG. 4, a portion of light incident on a light emitting surface 422 of the third lens 40c is reflected by the light emitting surface 422 to the object-side surface 441 of the third lens 40c. Since the protrusions 446 are formed at the object-side surface 441, incident angles of the light which reaches the object-side surface 441 are reduced compared to the case where the object-side surface 441 were simply a planar surface. Accordingly, total internal reflection in the third lens 40c is avoided, and most or even all the light incident on the object-side surface 441 can leave the third lens 40c through the object-side surface 441. Similarly, when a portion of the light passing through the third lens 40c is reflected to the image-side surface 442 or the side surface 443 of the third lens 40c, most or even all of the reflected light can leave the third lens 40c through the image-side surface 442 or the side surface 443.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A camera module, comprising:
a lens barrel; and
a lens received in the lens barrel, the lens comprising an optical portion located at a center thereof and a fixing portion around a periphery of the optical portion, wherein a plurality of protrusions is formed at an outside peripheral surface of the fixing portion, and surfaces of the protrusions are slanted relative to an optical axis of the lens barrel.

2. The camera module of claim 1, wherein a transverse cross-section of each of the protrusions is V-shaped.

3. The camera module of claim 2, wherein each of the protrusions comprises a first angled surface oriented at an oblique angle with respect to the optical axis and a second angled surface oriented at an oblique angle with respect to the optical axis and intersecting the first angled surface, with an angle formed between the first angled surface and the second angled surface in the range from 1° to 179°.

4. The camera module of claim 1, wherein the lens barrel comprises a black inner surface surrounding and facing the lens.

5. The camera module of claim 1, wherein the optical portion of the lens comprises a light incident surface and a light emitting surface at two opposite sides thereof, the fixing portion comprising an object-side surface extending radially outwardly from the light incident surface, an image-side surface extending radially outwardly from the light emitting surface and a peripheral side surface between the object-side surface and the image-side surface, the protrusions formed at the side surface.

6. The camera module of claim 5, wherein the protrusions are arranged side by side along a direction parallel to the optical axis.

7. The camera module of claim 6, wherein the protrusions are continuously arranged side by side.

8. The camera module of claim 5, wherein a plurality of protrusions is formed at the object-side surface, a plurality of protrusions is formed at the image-side surface, surfaces of the protrusions at the object-side surface are slanted relative to the optical axis, and surfaces of the protrusions at the image-side surface are slanted relative to the optical axis.

9. The camera module of claim 1, further comprising two other lenses received in the lens barrel and sandwiching the lens therebetween, with all the lenses aligned with an optical axis of the camera module.

10. The camera module of claim 1, further comprising two other lenses received in the lens barrel and sandwiching the lens therebetween, each of the other lenses comprising an optical portion located at a center thereof and a fixing portion around the optical portion, an outside peripheral surface of the fixing portion of one of the other lenses having a plurality of protrusions formed thereat, and surfaces of the protrusions of said one of the other lenses being slanted relative to the optical axis.

11. The camera module of claim 1, wherein the lens barrel comprises a cylinder and a flange extending radially inward from one end of the cylinder, the flange defining an aperture at a central portion thereof, the optical portion of the lens aligned with the aperture of the flange.

12. A camera module, comprising:
a lens barrel comprising a cylinder and a flange extending radially inward from one end of the cylinder, the flange defining an aperture at a central portion thereof; and
a lens received in the lens barrel and comprising an optical portion located at a center thereof and a fixing portion around the optical portion, an outside peripheral surface of the fixing portion of the lens shaped with a plurality of protrusions, surfaces of the protrusions being slanted relative to an optical axis of the lens barrel; and
wherein when light from an outside of the lens barrel enters the aperture and the optical portion of the lens, a portion of the light in the optical portion is reflected by the lens to the outside peripheral surface of the fixing portion, and the protrusions are shaped to reduce incident angles of the reflected light reaching the outside peripheral surface to facilitate at least some of the reflected light reaching the outside peripheral surface to pass through the protrusions to an outside of the lens.

13. The camera module of claim 12, wherein each of the protrusions comprises a first angled surface oriented at an oblique angle with respect to the optical axis and a second angled surface oriented at an oblique angle with respect to the optical axis and intersecting the first angled surface, with an angle formed between the first angled surface and the second angled surface in the range from 1° to 179°.

14. The camera module of claim 13, wherein the cylinder comprises a black inner surface around and facing the lens, the angles of the protrusions abutting the inner surface of the cylinder.

15. The camera module of claim 12, wherein the optical portion of the lens comprises a light incident surface and a light emitting surface at two opposite sides thereof, the outside peripheral surface of the fixing portion comprising an object-side surface extending outwardly from the light incident surface, an image-side surface extending outwardly from the light emitting surface and a periphery side surface between the object-side surface and the image-side surface, the protrusions formed at the side surface.

16. The camera module of claim 15, wherein a plurality of protrusions is formed at the object-side surface, a plurality of protrusions is formed at the image-side surface, surfaces of the protrusions at the object-side surface are slanted relative to the optical axis, and surfaces of the protrusions at the image-side surface are slanted relative to the optical axis.

17. The camera module of claim 12, further comprising two other lenses received in the lens barrel and sandwiching the lens therebetween, with all the lenses aligned with an optical axis of the camera module.

18. The camera module of claim 12, further comprising two other lenses received in the lens barrel and sandwiching the lens therebetween, each of the other lenses comprising an optical portion located at a center thereof and a fixing portion around the optical portion, an outside peripheral surface of the fixing portion of one of the other lenses having a plurality of protrusions formed thereat, and surfaces of the protrusions of said one of the other lenses being slanted relative to the optical axis.
